(19) United States
(12) Patent Application Publication
(10) Pub. No.: US 2002/0108820 A1
(43) Pub. Date: Aug. 15, 2002

(54) Lining devices for a disk brake

(75) Inventors: Rolf Von Sivers, Weissach-Flacht (DE); Claus Thomas, Remseck-Pattonville (DE)

Correspondence Address: Crowell & Moring, L.L.P., P.O. Box 14300, Washington, DC, 20044-4300, US

(73) Assignee: Dr. Ing. h.c.F. Porsche Aktiengesellschaft.

(21) Appl. No.: 10/028,720

(22) Filed: Dec. 28, 2001

(30) Foreign Application Priority Data
Feb. 10, 2001 (DE) 101 06 178.1

(51) Int. Cl. F16D 65/00

(52) U.S. Cl. 188/73.1

(57) ABSTRACT

Lining devices are suitable for a disk brake having a brake disk, preferably for a motor vehicle, in which the brake disk includes concave brake disk surfaces which cooperate with concave lining surfaces of the lining devices. Each lining device has a lining body with a convex lining surface and a lining support which is constructed as a plate and which has a planar bearing surface for the lining body. For achieving a defined wearing thickness of the lining body, a device for optimizing the friction volume of the lining body is provided between the convex lining surface and the bearing surface of the lining body.

This application claims the priority of German application 101 06 178.1, filed Feb. 10, 2001, the disclosure of which is expressly incorporated by reference herein.

### BACKGROUND AND SUMMARY OF THE INVENTION

The present invention relates to a lining device for a disk brake having a brake disk with a concave brake disk surface which cooperates with a convex lining surface of the lining device. The lining device includes a lining body with a convex lining surface, and a lining support which is constructed as a plate and which has a planar bearing surface for the lining body.

A lining device known from British Patent Document GB 1 586 465 has a lining body which is held in position on a bearing surface of a lining support. The bearing surface and the lining surface of the lining body, which faces a brake disk surface of a brake disk, have planar constructions.

German Patent Document DE 198 37 166 A1 shows a disk brake having a brake disk which is provided with concave brake disk surfaces. Convex lining surfaces of lining bodies cooperate with the concave brake disk surfaces, which lining surfaces, in conjunction with lining bodies, form lining devices. Each lining body is connected with a planar bearing surface of a pertaining lining support. The concave and convex lining surfaces, respectively, clearly reduce disturbing noise which can occur during braking of a motor vehicle equipped with such brakes at, for example, a pedestrian crossing or traffic lights. However, because of the convex design of the lining surfaces, the wearing thickness of the lining bodies is minimized, which impairs the operating time or the useful life of the lining devices.

It is therefore an object of the invention to provide a lining device that, despite having convex lining surfaces, has a normal stability.

According to the invention, this object is achieved by a device for optimizing a friction volume of the lining body provided between the convex lining surface of the lining body and the bearing surface of the lining support. Additional characteristics of the invention are reflected in the dependent claims. A process of stabilizing a lining device is also provided.

Among the principal advantages achieved by the invention is the advantage that the lining body friction volume optimizing device helps to provide each lining device having a convex lining surface with an unlimited service life characteristic. A device formed in this case by a widening or thickening of the lining support, which contributes to a defined friction volume, can be easily implemented. Since the thickening is formed by two individual plates situated on one another, the joining point of the individual plates contributes to targeted damping. Finally, the lining support, whether it consists of several pieces or of one piece, can be produced by methods known in the art.

Several embodiments of the invention are illustrated in the drawings and will be described in detail.

### BRIEF DESCRIPTION OF THE DRAWINGS

FIG. 1 is a lateral view of a disk brake having a brake disk and a caliper with lining devices according to German Patent Document DE 198 37 166 A1;

FIG. 2 is a detailed view of a first embodiment of a lining device according to the invention as it would appear in an area x of the structure shown in FIG. 1;

FIG. 3 is a view similar to FIG. 2 but showing a second embodiment of a lining device according to the invention.

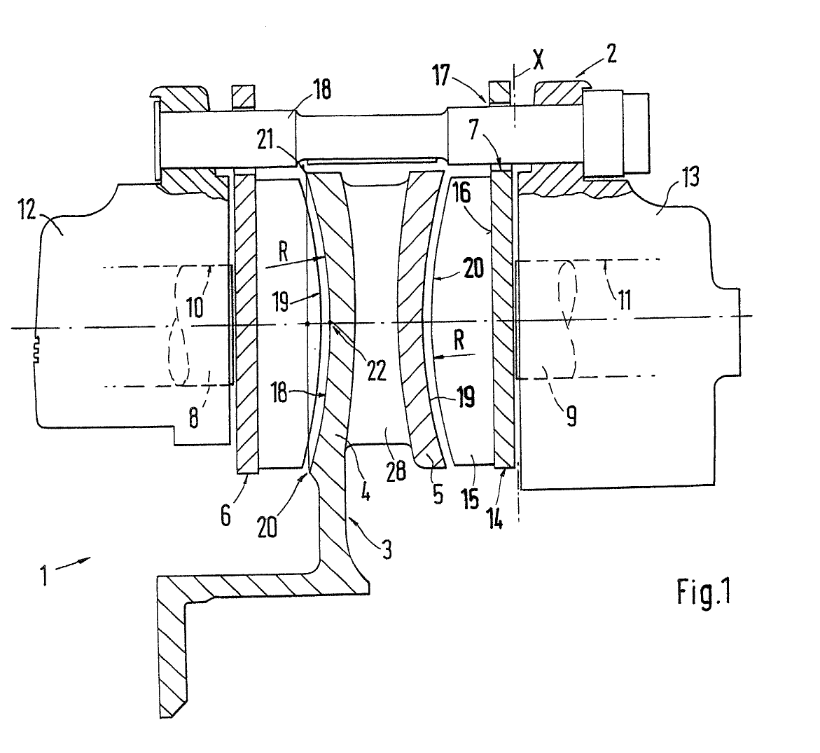

### DESCRIPTION OF THE PREFERRED EMBODIMENTS

A disk brake 1, which may be installed, for example, in a road vehicle, a rail vehicle, an airplane or the like, comprises a caliper 2 and a brake disk 3 with opposed friction ring halves 4, 5. The caliper 2 is constructed as a so-called fixed caliper which has floatingly disposed lining devices 6, 7 on both sides of the brake disk 3. The lining devices 6, 7 can be acted upon by pistons 8, 9. The pistons are axially movably disposed in bores 10, 11 of caliper housings 12, 13. Each lining device such as, for example, lining 7 comprises a lining support 14, constructed as a plate, and a lining body 15. The lining support and the lining body are fixedly connected with one another by way of a bearing surface such as the surface 16 of the lining support 14. The lining support 14 is provided with a bore 17 which surrounds a bearing pin 18. The lining device 7 is displaceably disposed on the bearing pin 18, that is, in its axial direction.

On the side facing the lining device 7, that is, on the friction ring half 4, the brake disk 3 has a concave brake disk surface 19. A brake lining surface 20 of the lining device 7 adjacent to the brake disk surface 19 corresponds with that brake disk surface 19 and, therefore, has a convex construction. The concavity of the brake disk surface 19 or the convexity of the brake lining surface 20, respectively, is determined by the radius R.

Between the bearing surface 16 of the lining support 14 and the brake lining surface 20, a device 21 is provided for optimizing a friction volume 22 of the lining device 6. The device 21 is illustrated by at least one locally constructed widening 23 of the lining body 14; this widening 23 extends away from the bearing surface 16 in the direction of the brake lining surface 20.

The widening 23 is a component of a local thickening which is provided in an area between a first boundary 25 and a second boundary 26. The boundaries 25, 26 extend transversely to a construction line 27 which extends in the radial direction of the friction ring surface 4. As a result of this configuration of the lining support 14, a thickness DI in an area 28 of the piston 9 is larger than, for example, thicknesses DII in the areas 29, 30 of the boundaries 25, 26, which is indicated by the relationship thickness DI>thicknesses DII. In this case, the thickness DI and the thicknesses DII start from a planar rearward side 31 of the lining support 14, which rearward side 31 extends at a distance from the bearing surface 16. As a result of the local thickening 24, the geometry-caused convexity Kv of the brake lining surface 20, which is adapted to the concavity of the brake disk surface, is compensated in favor of an optimized wearing thickness.

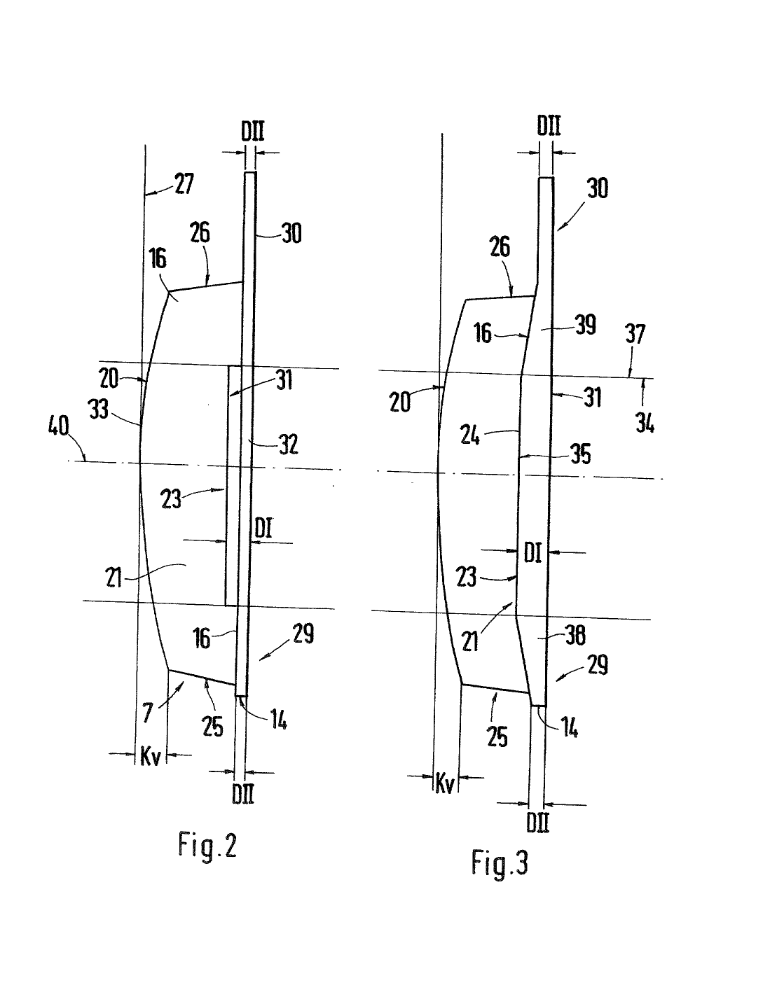

FIG. 2 shows the thickening 24 as formed by at least two individual plates 32 and 33 which rest on one another, which are connected with one another in a material-locking manner, and which have the same thicknesses in the illustrated embodiment. However, it is also conceivable to provide the two individual plates 32 and 33 with different thicknesses.

In FIG. 3, the shape of the bearing surface 16 follows approximately the course of the concave brake disk surface 20. In this case, the bearing surface 16 is constructed in its bearing surface center area 34 as a planar section 35. On ends 36, 37 of the planar section, the lining support 14 is provided with tapers 38, 39. Finally, the lining support 14 may have a symmetrical construction on both sides of a longitudinal center plane which includes a longitudinal center plane of the piston 40.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A lining device for a disk brake having a brake disk with a concave brake disk surface which cooperates with a convex lining surface of the lining device, said lining device comprising:
a lining body with a convex lining surface,
a lining support which is constructed as a plate and which has a planar bearing surface for the lining body, and
a device for optimizing a friction volume of the lining body provided between the convex lining surface of the lining body and the bearing surface of the lining support.

2. The lining device according to claim 1, wherein the device for optimizing the friction volume is formed by a widening of the lining support which is provided at least locally and which extends in a direction of the lining surface.

3. The lining device according to claim 2, wherein the widening is a thickening which is formed by two individual plates situated on one another.

4. The lining device according to claim 3, wherein the individual plates are connected with one another in a material-locking manner.

5. The lining device according to claim 3, wherein the individual plates have the same thicknesses.

6. The lining device according to claim 3, wherein the individual plates have different thicknesses.

7. The lining device according to claim 1, wherein the bearing surface of the lining support has a shape which is adapted approximately to a course of the convex lining surface.

8. The lining device according to claim 7, wherein the shape of the bearing surface is such that a bearing surface center area is a planar section which is bounded by tapers.

9. The lining device according to claim 1, wherein said brake disk is a motor vehicle brake disk.

10. The lining device according to claim 2, wherein the bearing surface of the lining support has a shape which is adapted approximately to a course of the convex lining surface.

11. The lining device according to claim 10, wherein the shape of the bearing surface is such that a bearing surface center area is a planar section which is bounded by tapers.

12. A process of stabilizing a lining device for a disk brake having a brake disk with a concave brake disk surface which cooperates with a convex lining surface of the lining device, said lining device including a lining body with a convex lining surface, and a lining support which is constructed as a plate and which has a planar bearing surface for the lining body, comprising optimizing a friction volume of the lining body with a device provided between the convex lining surface of the lining body and the bearing surface of the lining support.

13. The process according to claim 12, wherein the device provided between the convex lining surface and the bearing surface is formed by a widening of the lining support which is provided at least locally and which extends in a direction of the lining surface.

14. The process according to claim 13, wherein the widening is a thickening which is formed by two individual plates situated on one another.

15. The process according to claim 14, wherein the individual plates are connected with one another in a material-locking manner.

16. The process according to claim 14, wherein the individual plates have the same thicknesses.

17. The process according to claim 14, wherein the individual plates have different thicknesses.

18. The process according to claim 12, wherein the bearing surface of the lining support has a shape which is adapted approximately to a course of the convex lining surface.

19. The process according to claim 18, wherein the shape of the bearing surface is such that a bearing surface center area is a planar section which is bounded by tapers.

20. The process according to claim 12, wherein said brake disk is a motor vehicle brake disk.

21. The process according to claim 13, wherein the bearing surface of the lining support has a shape which is adapted approximately to a course of the convex lining surface.

22. The process according to claim 21, wherein the shape of the bearing surface is such that a bearing surface center area is a planar section which is bounded by tapers.
